(19) United States
(12) Patent Application Publication
(10) Pub. No.: US 2024/0314587 A1
(43) Pub. Date: Sep. 19, 2024

(54) SYSTEMS AND METHODS FOR PROVIDING SAAS OPTIMIZATION AND SECURITY AS A SERVICE OFFERING

(71) Applicant: CradlePoint, Inc., Boise, ID (US)

(72) Inventors: Deepak Nair, Boise, ID (US); Saqib Syed, Boise, ID (US); Fengpei Zhang, Boise, ID (US); Nataranjan Venkataraman, Boise, ID (US); Anubhav Arora, Boise, ID (US); Ahmad Rostami, Boise, ID (US); Jitendra Manocha, Boise, ID (US); Jose Luis Mariz, Boise, ID (US)

(73) Assignee: CradlePoint, Inc., Boise, ID (US)

(21) Appl. No.: 18/604,199

(22) Filed: Mar. 13, 2024

Related U.S. Application Data
(60) Provisional application No. 63/489,809, filed on Mar. 13, 2023.
(60) Provisional application No. 63/579,368, filed on Aug. 29, 2023.
(60) Provisional application No. 63/539,425, filed on Sep. 20, 2023.
(60) Provisional application No. 63/616,063, filed on Dec. 29, 2023.

(51) Int. Cl. H04W 24/02; H04W 4/30

(52) U.S. Cl. CPC H04W 24/02; H04W 4/30

(57) ABSTRACT

Systems and methods for providing Software as a Service (SaaS) optimization as a service offering in a 5G network, the system including a network device, including a device processor, configured to communicate over at least a 5G network wherein the network device comprises a set of instructions to cause the device processor to implement an enterprise policy for SaaS optimization over 5G network infrastructure, a data center, including a data center processor, in communication with at least the 5G network wherein the data center includes a set of instructions to cause the data center processor to respond to the network device implementing the enterprise policy for SaaS optimization by mapping the enterprise policy for SaaS optimization to the 5G network infrastructure, and a service account processor that includes a set of instructions to provide a service account control plane configured to enable a user to configure the enterprise policy for SaaS optimization.

### CROSS-REFERENCE TO RELATED APPLICATIONS

This application, under 35 U.S.C. § 119, claims the benefit of U.S. Provisional Patent Application Ser. No. 63/489,809 filed on Mar. 13, 2023, and entitled “Application Programming Interface (API) Engine For Enhanced Cellular Network Functionality,” U.S. Provisional Patent Application Ser. No. 63/579,368 filed on Aug. 29, 2023, and entitled “Systems And Methods For Providing Network Security As A Service,” U.S. Provisional Patent Application Ser. No. 63/539,425 filed on Sep. 20, 2023, and entitled “Providing SaaS Optimization As A Service Offering,” and U.S. Provisional Patent Application Ser. No. 63/616,063 filed on Dec. 29, 2023, and entitled “Application Programming Interface (API) Engine For Enhanced Cellular Network Functionality,” of which the contents of each are hereby incorporated by reference herein.

### FIELD OF THE DISCLOSURE

This disclosure relates generally to wireless networking. More particularly, this disclosure relates to systems and methods for offering software as a service (Saas) optimization and security as service options in fifth generation (5G) mobile networks.

### BACKGROUND

The growth of 5G networks enables a new kind of network designed to connect virtually everyone and everything together including machines, objects, and devices. 5G wireless technology is meant to deliver higher multi-Gbps peak data speeds, ultra low latency, more reliability, massive network capacity, increased availability, and a more uniform user experience to more users.

However, most entities (e.g., corporations, businesses, government agencies, etc.), typically use a wired, or mostly wired, network for, among other things, reliability and security reasons. For example, wired, or mostly wired, networks enable an entity to employ a software-defined wide area network (SD-WAN), or the like, to enable the entity to provide a uniform quality of experience (QoE) and implement network policies and the like. Additionally, SD-WANs allow network slicing (e.g., multiple independent networks existing on the same physical network using different “slices” of the same spectrum band). This allows entities to accommodate different application requirements for security, reliability, and performance on the same network.

Additionally, wired, or mostly wired, networks enable efficiency, diagnostic, and troubleshooting features such as artificial intelligence for IT operations (AIOps), root cause analysis (RCA), fault line detection, and the like. Many of the above, and other, features are not currently or conveniently available over 5G networks. Other drawbacks also exist.

5G networks also have some unique features that present issues for entities using them for network communications and the like. For example, a variety of fixed and mobile devices (e.g., remote work sites, Internet of Things (IoT) devices, vehicles, geographically distributed offices, and the like) may be communicating over the network each having different protocols and capabilities that need accommodation. Likewise, 5G bandwidth is variable and fluctuates with signal strength and quality and the loss (i.e., dropping) of a cellular network can contribute to a variable, less-than-desirable, user QoE. Further, links are often metered with inconsistent data plans between the various cellular providers. Other drawbacks, inconveniences, and issues also exist

### SUMMARY

Accordingly, disclosed embodiments address the above and other drawbacks, inconveniences, and issues with existing systems and methods. Disclosed embodiments include a system for providing Software as a Service (SaaS) optimization as a service offering in a 5G network. Embodiments of the system include a network device, including a device processor, configured to communicate over at least a 5G network wherein the network device comprises a set of instructions to cause the device processor to implement an enterprise policy for SaaS optimization over 5G network infrastructure, a data center, including a data center processor, in communication with at least the 5G network wherein the data center includes a set of instructions to cause the data center processor to respond to the network device implementing the enterprise policy for SaaS optimization by mapping the enterprise policy for SaaS optimization to the 5G network infrastructure, and a service account processor that includes a set of instructions to provide a service account control plane configured to enable a user to configure the enterprise policy for SaaS optimization.

Disclosed embodiments also include a system for providing SaaS optimization as a service offering in a 5G network, the system including a service account gateway, including a gateway processor, configured to include a set of instructions to provide a service account control plane configured to enable a user to configure at least one enterprise SaaS optimization policy, and a set of instructions to push the at least one enterprise SaaS optimization policy to a network device, the network device, including a device processor, configured to communicate over at least a 5G network wherein the network device comprises a set of instructions to cause the device processor to map the at least one enterprise SaaS optimization policy to a 5G network infrastructure, and a data center, including a data center processor, in communication with at least the 5G network wherein the data center includes a set of instructions to cause the data center processor to maintain the at least one enterprise SaaS optimization policy.

Also disclosed are embodiments of a method for providing SaaS optimization as a service offering in a 5G network. Embodiments of the method include configuring a network device, including a device processor, to communicate over at least a 5G network wherein the network device comprises a set of instructions to cause the device processor to implement an enterprise policy for SaaS optimization over 5G network infrastructure, communicating from a data center, including a data center processor, with at least the 5G network wherein the data center includes a set of instructions to cause the data center processor to respond to the network device implementing the enterprise policy for SaaS optimization by mapping the enterprise policy for SaaS optimization to the 5G network infrastructure, and configuring a service account processor that includes a set of instructions to provide a service account control plane configured to enable a user to configure the enterprise policy for SaaS optimization.

Embodiments also include a method for providing SaaS optimization as a service offering in a 5G network, the method including configuring a service account gateway, including a gateway processor, to include a set of instructions to provide a service account control plane configured to enable a user to configure at least one enterprise SaaS optimization policy, and a set of instructions to push the at least one enterprise SaaS optimization policy to a network device, configuring the network device, including a device processor, to communicate over at least a 5G network wherein the network device comprises a set of instructions to cause the device processor to map the at least one enterprise SaaS optimization policy to a 5G network infrastructure, and communicating from a data center, including a data center processor, with at least the 5G network wherein the data center includes a set of instructions to cause the data center processor to maintain the at least one enterprise SaaS optimization policy. Other embodiments also exist.

### BRIEF DESCRIPTION OF THE DRAWINGS

FIGS. 1A-D are schematic illustrations of SD-WAN deployments in accordance with disclosed embodiments.

FIG. 2 is a schematic illustration of over-the-air software and policies updates in accordance with disclosed embodiments.

FIG. 3 is a schematic illustration of a retail use case in accordance with disclosed embodiments.

FIG. 4 is a schematic illustration of a retail use case in accordance with disclosed embodiments.

FIG. 5 is a schematic illustration of a government use case in accordance with disclosed embodiments.

FIGS. 6A-6B are schematic illustrations of network slicing in accordance with disclosed embodiments.

FIG. 7A is a schematic illustration of automated provisioning of a network slice on a router device 100 in accordance with disclosed embodiments.

FIG. 7B is a schematic illustration of a network indicating a change in network slice to a device in accordance with disclosed embodiments.

FIG. 8 is a schematic illustration of an exemplary embodiment for addressing ATSSS issues in accordance with the disclosure.

FIG. 9 is a schematic illustration of an exemplary embodiment for addressing MEC issues in accordance with the disclosure.

FIG. 10 is a schematic illustration of an exemplary embodiment for addressing service resiliency and band aggregation issues in accordance with the disclosure.

FIG. 11 is a schematic illustration of a system for providing SaaS optimization as a service offering in accordance with disclosed embodiments.

FIG. 12 is a schematic illustration of a system for providing an isolated secure network in the macro in accordance with disclosed embodiments.

FIG. 13 is a schematic illustration of a system for providing service resiliency and band aggregation in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

Accordingly, disclosed embodiments provide a disconnected architecture for network security by providing that an end point cannot directly request for a network slice, by allowing an end point device to be dynamically disabled by the network, and by providing the vertical application layer (VAL) server to allow network configuration management (NCM) under its own account management and carrier binding capabilities in a managed services use case.

Among other things, disclosed embodiments enable the providing of feedback on network slice usage and slice QoE at the user equipment. Likewise, disclosed embodiments provide feedback that can be used for enhancing slice management.

Additionally, disclosed embodiments can be implemented with any modem or device hardware (i.e., embodiments are modem hardware agnostic). Further, disclosed embodiments can be staged and managed using non-cellular connections (e.g., ethernet, WAN/Satellite, and the like). Disclosed embodiments also allow for the addition of application type in the configuration and the control flow to enable enterprise application type mapping. Other features are also disclosed.

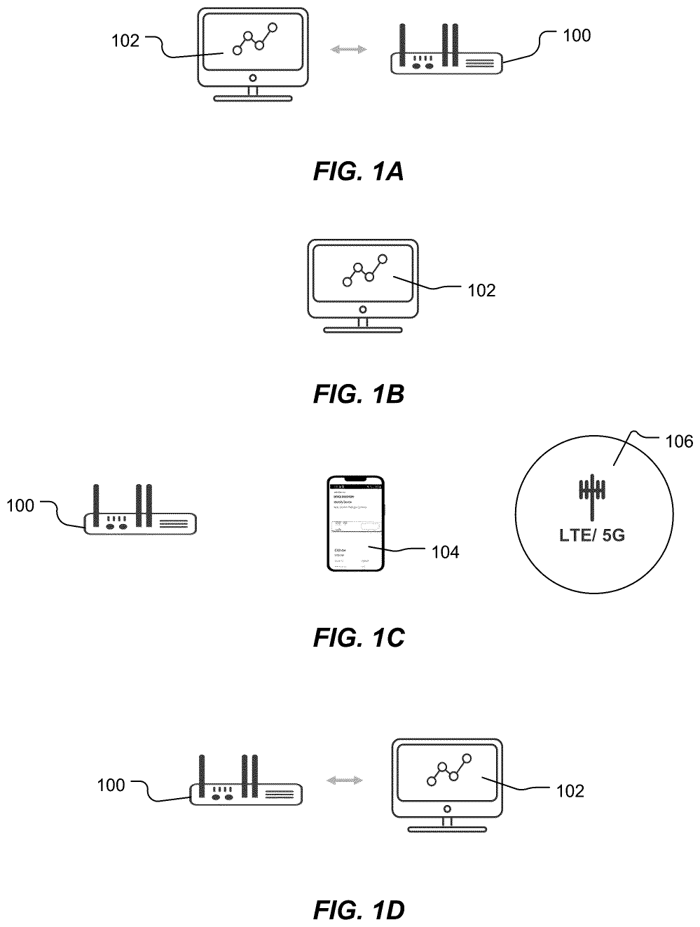

FIGS. 1A-D are schematic illustrations of SD-WAN deployments in accordance with disclosed embodiments. As indicated schematically in FIG. 1A, once a customer has ordered an SD-WAN device (e.g., a router 100) a supplier registers the router 100 in the customer's cloud-based service account 102 (e.g., NetCloud Service, provided by Cradlepoint of Boise, Idaho). Registration may include assigning license rights and providing the customer the option to request a subscriber identity module (SIM) card to ship with the router 100. Once registered, at FIG. 1B, the customer can pre-stage configuration of the router 100 using the cloud-based service account 102. Pre-stage configuration may include setting user preferences, changing device (e.g., router 100) capabilities, and the like.

At FIG. 1C, once the SD-WAN device (e.g., router 100) arrives at the customer location, the customer may install the router 100. For example, the customer may use a Verify Application 104 running on a cellular device communicating over a cellular network 106 (e.g., LTE, 4G, 5G, etc.).

At FIG. 1D, upon successful installation, the router 100 connects to the customer's cloud-based service account 102 and automatically downloads any licensed software (e.g., as configured during registration of the router 100) and any pre-stage configurations and settings.

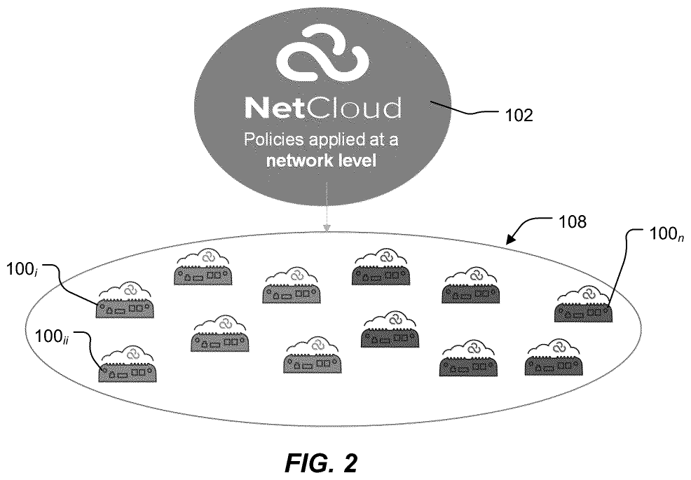

FIG. 2 is a schematic illustration of over-the-air software and policies updates in accordance with disclosed embodiments. As illustrated, an entity's cloud service account 102 may be used to set SD-WAN network 108 policies and to upgrade, patch, bulk configure, or the like the SD-WAN network 108 routers 100ᵢ-100ₙ. For example, a single application-based traffic steering policy can be applied across an SD-WAN network 108 consisting of multiple device types.

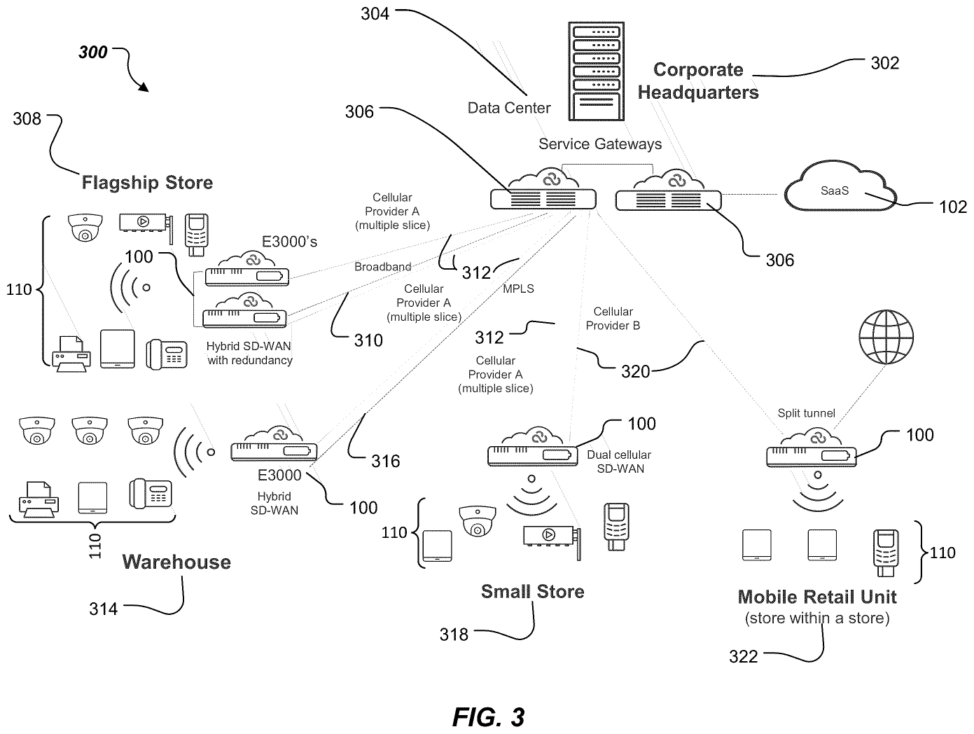

FIG. 3 is a schematic illustration of a retail use case in accordance with disclosed embodiments. As illustrated, a retail entity 300 may have a corporate headquarters 302 with a data center 304 and one or more service gateways 306 that also may communicate with the retail entity's 300 cloud service account 102.

Retail entity 300 may also include one or more flagship stores 308 that include numerous devices 110 (e.g., security cameras, Point of Sale (POS) devices, tablets, printers, VoIP phones, cash registers, computers, etc.) that communicate, wirelessly or otherwise, with one or more routers 100, which may be enterprise routers such as E3000 enterprise routers sold by Cradlepoint of Boise, Idaho. Flagship stores 308 may have a hybrid SD-WAN in which routers 100 communicate with service gateways 306 over a broadband (e.g., wired) connection 310 or over a cellular connection 312 from a cellular provider. Cellular connection 312 may be a 5G multiple slice connection as disclosed herein.

Retail entity 300 may also include one or more warehouses 314. Similar to flagship store 308, warehouse 314 may include a hybrid SD-WAN with a plurality of devices 110 that communicate, wirelessly or otherwise, with one or more routers 100 which may be enterprise routers. Communication may be a cellular connection (e.g., 5G multiple slice) or over a multi-protocol label switching (MPLS) connection 316.

Retail entity 300 may also include one or more small stores 318 (i.e., smaller in size, amount of merchandize, type of merchandize, or the like, than flagship store 308) that include numerous devices 110 that communicate, wirelessly or otherwise, with one or more routers 100. Small store 318 may implement a dual cellular SD-WAN that communicates with service gateway 306 over a first cellular connection 312 and a second cellular connection 320.

Retail entity 300 may also include one or more mobile retail units 322 which may comprise a kiosk location within another retail space, a van or other vehicle equipped for mobile sales, or the like. Mobile retail unit 322 may communicate with service gateway 306 via a router 100 over a cellular connection (e.g., cellular connection 320). In this case, router 100 may comprise a split tunnel router or the like.

As should be apparent to those of ordinary skill in the art having the benefit of this disclosure, the above-disclosed retail entity 300 configuration enables a number of benefits. For example, the herein disclosed configurations provide the ability to leverage 5G for agility and time to service, provide link and service provider diversity, are simple to deploy with support for overlapping IPs and tunnel orchestration, provide the ability to prioritize POS traffic across the entire network in a simple manner, enable cellular provider visibility and prioritization, provide direct Internet access, and the like.

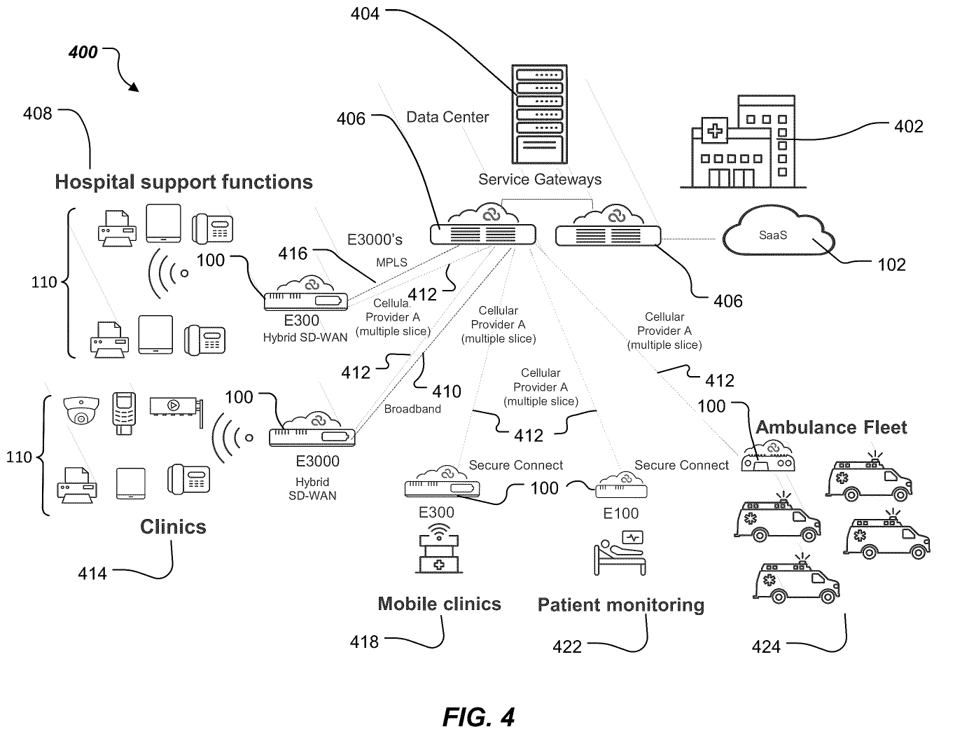

FIG. 4 is a schematic illustration of a healthcare use case in accordance with disclosed embodiments. As illustrated, a healthcare entity 400 may have a headquarters or main hospital 402 with a data center 404 and one or more service gateways 406 that also may communicate with the healthcare entity's 400 cloud service account 102.

Healthcare entity 400 may also include one or more hospital support functions 408 (e.g., administrative or other functions) that include numerous devices 110 (e.g., security cameras, tablets, printers, VoIP phones, cash registers, computers, etc.) that communicate, wirelessly or otherwise, with one or more routers 100, which may be enterprise routers such as E3000 enterprise routers sold by Cradlepoint of Boise, Idaho. Support functions 408 may have a hybrid SD-WAN in which routers 100 communicate with service gateways 406 over a MPLS connection 416 or over a cellular connection 412 from a cellular provider. Cellular connection 412 may be a 5G multiple slice connection as disclosed herein.

Healthcare entity 400 may also include one or more clinics 414 that may be remotely located. Similar to support functions 408, clinics 414 may include a hybrid SD-WAN with a plurality of devices 110 that communicate, wirelessly or otherwise, with one or more routers 100 which may be enterprise routers. Communication may be a cellular connection 412 (e.g., 5G multiple slice) or over a broadband connection 410.

Healthcare entity 400 may also include one or more mobile clinics 418 (i.e., van or other vehicle based or the like) that include numerous devices 110 that communicate, wirelessly or otherwise, with one or more routers 100. Mobile clinic 418 may implement a secure connect router 100 that communicates with service gateway 406 over a first cellular connection 412 which may be a multiple slice connect.

Healthcare entity 400 may also include one or more patient monitoring units 422 which may comprise an at-home monitoring system, an in-hospital monitoring system, a hospice monitoring system, or the like. Patient monitoring unit 422 may communicate with service gateway 406 via a router 100 over a cellular connection (e.g., cellular connection 412). In this case, router 100 may comprise a secure connect router 100 or the like.

Healthcare entity 400 may also include one or more ambulance fleet units 424 which may comprise mobile ambulance units 424, or the like, that may communicate with service gateway 406 via a router 100 over a cellular connection (e.g., cellular connection 412). In this case, router 100 may comprise a secure connect router 100 or the like.

As should be apparent to those of ordinary skill in the art having the benefit of this disclosure, the above-disclosed healthcare entity 400 configuration enables a number of benefits. For example, the herein disclosed configurations provide the ability to leverage 5G for agility and time to service, provide link and service provider diversity, are simple to deploy with support for overlapping IPs and tunnel orchestration, provide the ability to prioritize health records or medical device traffic across the entire network in a simple manner, enable cellular provider visibility and prioritization, provide direct Internet access, and the like.

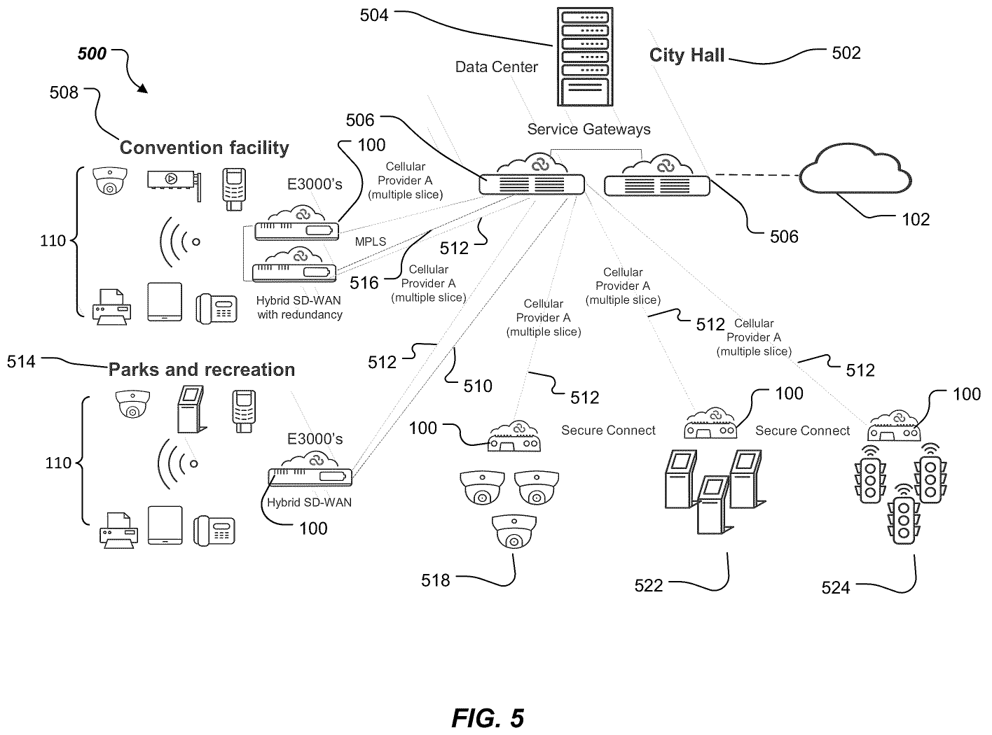

FIG. 5 is a schematic illustration of a government use case in accordance with disclosed embodiments. As illustrated, a government entity 500 may have a headquarters or city hall 502 with a data center 504 and one or more service gateways 506 that also may communicate with the government entity's 500 cloud service account 102.

Government entity 500 may also include one or more public meeting spaces, such as convention facility 508, or the like, that include numerous devices 110 (e.g., security cameras, tablets, printers, VoIP phones, cash registers, computers, etc.) that communicate, wirelessly or otherwise, with one or more routers 100, which may be enterprise routers such as E3000 enterprise routers sold by Cradlepoint of Boise, Idaho. Convention facility 508 may have a hybrid SD-WAN in which routers 100 communicate with service gateways 506 over a MPLS connection 516 or over a cellular connection 512 from a cellular provider. Cellular connection 512 may be a 5G multiple slice connection as disclosed herein.

Government entity 500 may also include one or more divisions or departments such as a Parks and Recreation department 514 that may have geographically distributed locations and the like. Government departments 514 may include a hybrid SD-WAN with a plurality of devices 110 that communicate, wirelessly or otherwise, with one or more routers 100 which may be enterprise routers. Communication may be a cellular connection 512 (e.g., 5G multiple slice) or over a broadband connection 510.

Government entity 500 may also include one or more functions or areas of responsibility, such as security systems 518, information kiosks 522, traffic monitoring and control 524, and the like, that include numerous devices 110 that communicate, wirelessly or otherwise, with one or more routers 100. Each of these systems may implement a secure connect router 100 that communicates with service gateway 506 over a cellular connection 512 which may be a multiple slice connect.

As should be apparent to those of ordinary skill in the art having the benefit of this disclosure, the above-disclosed government entity 500 configuration enables a number of benefits. For example, the herein disclosed configurations provide the ability to leverage 5G for agility and time to service, provide link and service provider diversity, are simple to deploy with support for overlapping IPs and tunnel orchestration, provide the ability to prioritize high priority traffic across the entire network in a simple manner, enable cellular provider visibility and prioritization, provide direct Internet access, and the like.

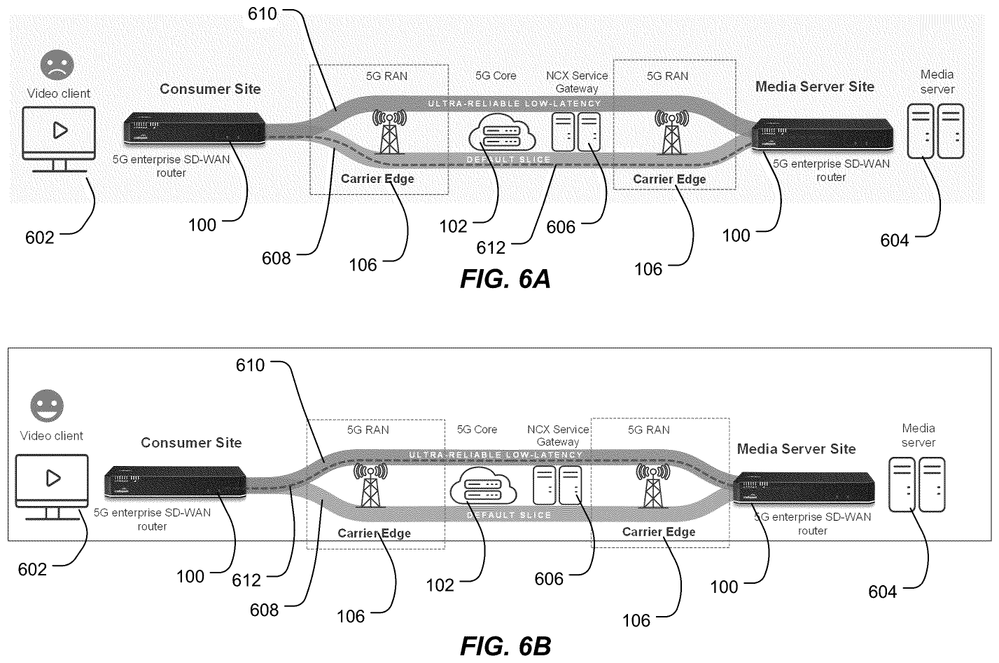

FIGS. 6A-6B are schematic illustrations of network slicing in accordance with disclosed embodiments. As disclosed herein, network slicing is helpful for, among other things, its ability to support multiple different virtual networks over a shared 5G infrastructure extending from user equipment (UE) to radio access networks (RAN), to core, to transport. Each network slice represents an isolated end-to-end network tailored to meet the requirements of different categories of applications. For example, a number of categories of application have been defined, such as Enhanced Mobile Broadband (eMBB), Ultra Reliable Low Latency Communications (URLLC), Machine-to-machine (mMTC), Public safety, and mobile network operators (virtual or otherwise) can also define their own slices. Disclosed embodiments herein enable the ability to create multi-band slices within each application category.

FIG. 6A is a schematic illustration of an SD-WAN policy being applied to steer traffic 612 across a default slice 608. As illustrated, a video client 602 may wish to stream a movie or other content residing on a media server 604. Video client 602 accesses the media server 604 via a router 100, which is a 5G router, that communicates over a cellular or other network 106. Video quality may be impacted (e.g., it may lag) when communicated on default slice 608 due to congestion within that slice.

As illustrated in FIG. 6B, client 603 may use a client cloud service account 102 and service gateways 606 to configure router 100 to communicate the video content traffic 612 over URLLC slice 610 instead of default slice 608. In this manner video quality is now high (e.g., non-lagging) due to the isolated traffic in the URLLC slice 610.

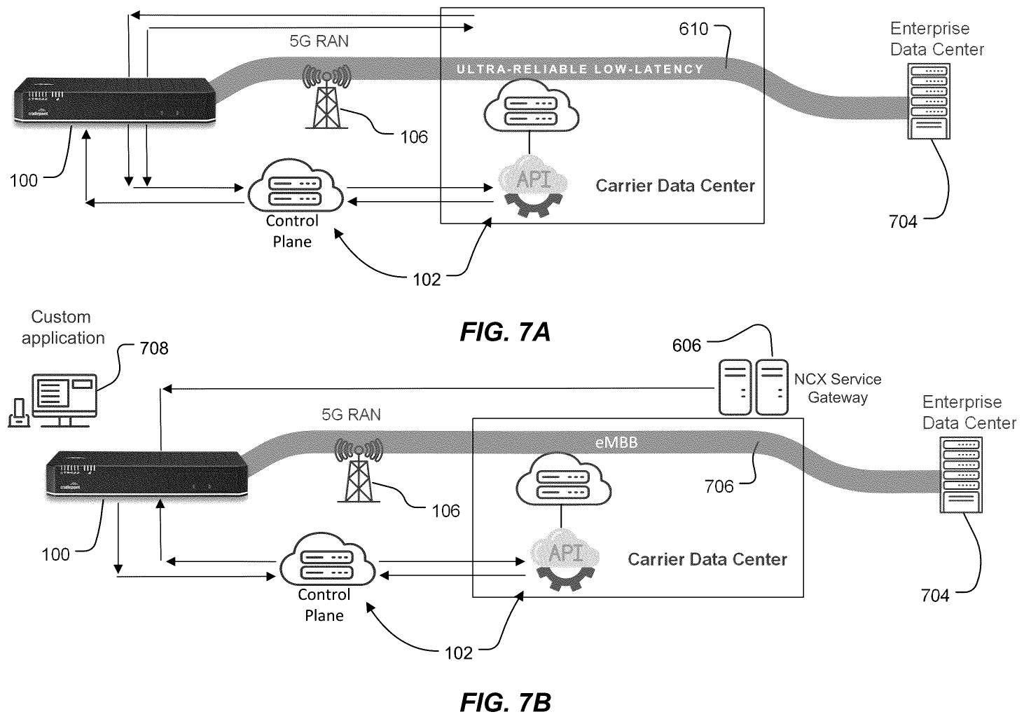

FIG. 7A is a schematic illustration of automated provisioning of a network slice on a router device 100 in accordance with disclosed embodiments. Provisioning of a slice may occur on registration or on a subsequent change of a slice. As indicated, a device, such as router 100, registers to the network (e.g., 5G network 106 in communication with an enterprise data center 704) and sends an identifier (e.g., MSISDN identifier) to the network

106. Network 106 returns slice (e.g., URLL slice 610) selection information (e.g., S-NSSAI) for all subscribed slices including the default slice (e.g., 608). The enterprise associated with enterprise data center 704 may use a control plane in cloud service account 102 to provision private data units for a slice (e.g., 610) based on parameters such as MSISDN, S-NSSAI, enterprise name, type, and the like. Likewise, a network slice definition is provided through service account 102 control plane for parameters such as MSISDN, S-NSSAI, quality of service identifiers (e.g., 5QI), Application type, registration area, tracking area, cell ID, and the like. In some embodiments, provisioning may be accomplished by using a network exposure function to query the unified data repository and the policy control function. The cloud service account 102 pushes a configuration to the network device (e.g., router 100) to create a unique protocol data unit (PDU) for the slice (e.g., 610). Embodiments of the PDU may comprise S-NSSAI, 5QI, Application type, registration area, tracking area, cell ID, and the like.

FIG. 7B is a schematic illustration of an enterprise network (e.g., 704) indicating a change in network slice (e.g., to enhanced mobile broadband slice 706) to a device 100 in accordance with disclosed embodiments. As shown, enterprise policy maps the application to the desired slice (e.g., 610). Enterprise may define a policy for a custom application 708 as being, for example, rated as business critical. Further, business critical applications may be assigned to eMBB slice 706. That enterprise policy is then mapped to the carrier infrastructure (e.g., 106) using parameters such as the assigned enterprise policy, MSISDN, Network PDU definition, network current metrics for a slice, application details, and the like. The carrier trouble shooting data (e.g., accessed through control plane of service network 102) monitors those same parameters and the carrier can then control the slice that is assigned (e.g., 706). In this manner the enterprise created policy is mapped to the 5G infrastructure through APIs allowing the application priority to be maintained across the carrier network. The network exposure function may be used to provide feedback on the network device 100 for experience on the slice 706.

As will be apparent to those of skill in the art having the benefit of this disclosure, the above-described solutions allow a network (e.g., network 106), among other things, to analyze usage data for capacity planning, to use AI analysis for service level agreement (SLA) management, to disconnect compromised devices or unauthorized devices that are trying to use slice, as well as other features.

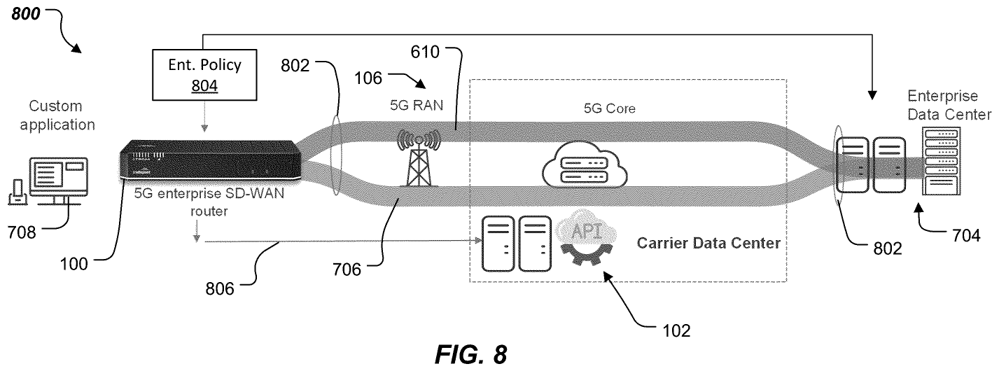

FIG. 8 is a schematic illustration of an exemplary embodiment for addressing ATSSS issues in accordance with the disclosure. As shown schematically, system 800 may be implemented to maintain link bonding from end-to-end throughout a network. Link bonding may be important in applications such as, for example, communication with a first responder in a mobile vehicle where connection with the network may change as the vehicle moves (e.g., from 5G to LTE to 4G, etc.) which can lead to dropped connections or loss of data and the like. Link bonding (shown schematically at 802) is from end-to-end of the network (e.g., from user router 100 to enterprise data center 704 and back).

As indicated schematically a user's custom application 708 may require link bonding (e.g., a high data rate link or the like) of multiple network slices (e.g., URLL slice 610 and eMBB slice 706). An enterprise defined policy 804 defining the link bonding 802 is installed on the user's router 100 and communicated to the link bonding termination point at the enterprise data center 704. As indicated at 806 the enterprise link bonding policy 804 is mapped to the 5G infrastructure through APIs 102 that enable the bonding 802 to be maintained across carrier network 106. For example, carrier 106 core integration may inform the Non-3GPP Interworking Function (N3IWF) about the bonded links 802 for subscription management and advanced core functions. In exemplary embodiments an SLA or the like can be used to define and maintain the link bonding 802 and prevent dropped connections and other issues while maintaining the QoS the user requested. Other embodiments, advantages, and features also exist.

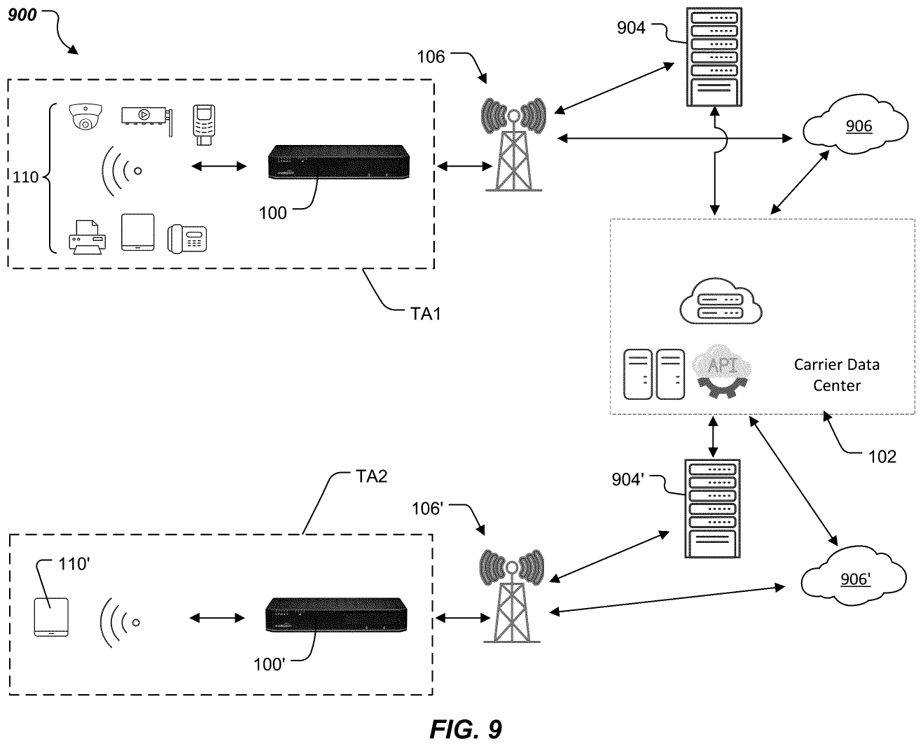

FIG. 9 is a schematic illustration of an exemplary system 900 for addressing MEC issues in accordance with the disclosure. As illustrated and discussed herein a number of devices 110 access a cellular network 106 using a router 100 and may communicate with either a data center 904 or a cloud-based service 906. The devices 110 and router 100 are generally in the same geographic cell location to access a particular cellular antenna (e.g., 106) which may be grouped as a 5G Tracking Area (TA) labeled as TA1 in FIG. 9. Each TA may be assigned as a Registration Area (RA) to the endpoint enabling local breakouts and localized services to the registered endpoints. Data collection by router 100 indicates to the carrier data center 102 the cell tower an location and GPS location of the endpoint (e.g., device 110) and the same is transmitted to the 5G network. Then, when a user leaves a TA, as schematically indicated by device 110′ entering TA2 and accessing the 5G network using router 100′, the carrier data center 102 will automatically learn the updated location (e.g., cell tower 106′) and can steer traffic to other geographically nearby resources such as data center 904′ or cloud services 906′. Among other things, this can improve data transmission speeds and overall QoE for the user. In some embodiments Network Address Translation (NAT) information may be used to direct traffic. Other embodiments are also possible.

In some embodiments the solution can optimize traffic for SaaS and Security purposes. For example, a 5G provider network 106 controlled solution that leverages the MEC and 5G elements like the entitlement server and the N3IWF can provide a resilient highly available network by duplicating traffic on multiple 5G slices (e.g., 610, 706, etc.).

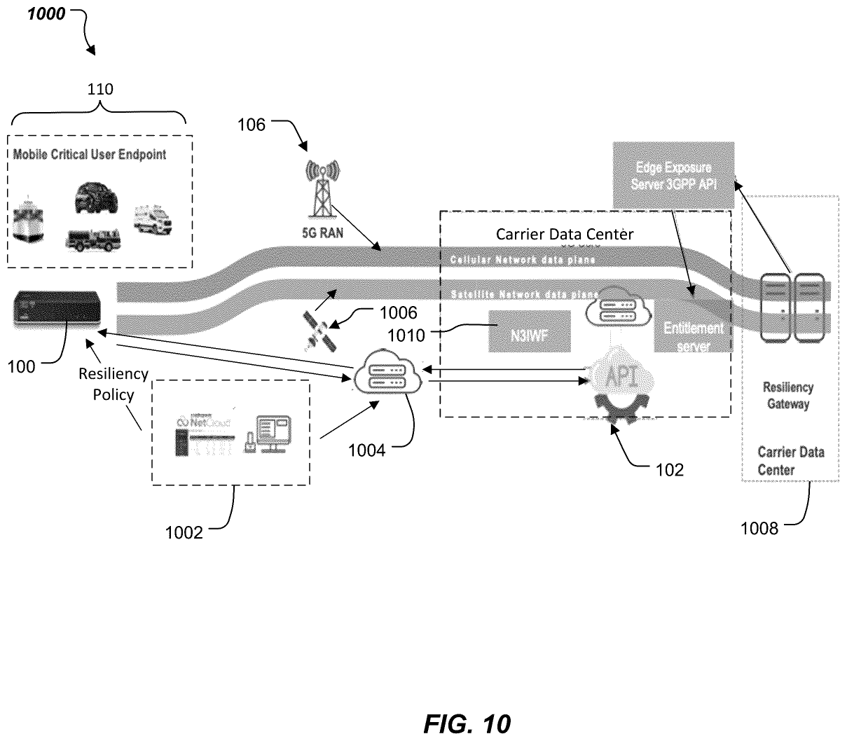

FIG. 10 is a schematic illustration of an exemplary embodiment 1000 for addressing service resiliency and band aggregation issues in accordance with the disclosure. As illustrated, a cloud service account 102 (e.g., Net Cloud Manager by Cradlepoint of Boise, Idaho) allows an enterprise 1002 to use the cloud service account 102 control plane 1004 to create a resiliency policy which is sent down, as indicated by the arrow, to a router 100 or other endpoint. The resiliency policy is mapped to the carrier network 106, 1006 using parameters such as MSISDN, Application, resiliency level, etc. The network 106, 1006 operator may provide resiliency level as a subscription wherein a carrier query for the infrastructure security may be based on parameters such as MSISDN, Application, resiliency level, etc., and carrier control may be communicated based on the same parameters. The API infrastructure in carrier data center 102 provides location of the resiliency gateway 1008 to the connecting end user device 110 (e.g., using parameters such as MSISDN, Application, resiliency gateway IP, resiliency infrastructure IP address and the like). The device 110 location may be identified using the N3IWF function 1010 registration area. The resiliency gateway 1008 provides the termination point for all flows for that application from any interface on a terrestrial (e.g., 106) or non-terrestrial (e.g., 1006) network. Some embodiments may include additional functionality such as Forward Error Correction, and the like, as part of the resiliency service. Other embodiments are also possible.

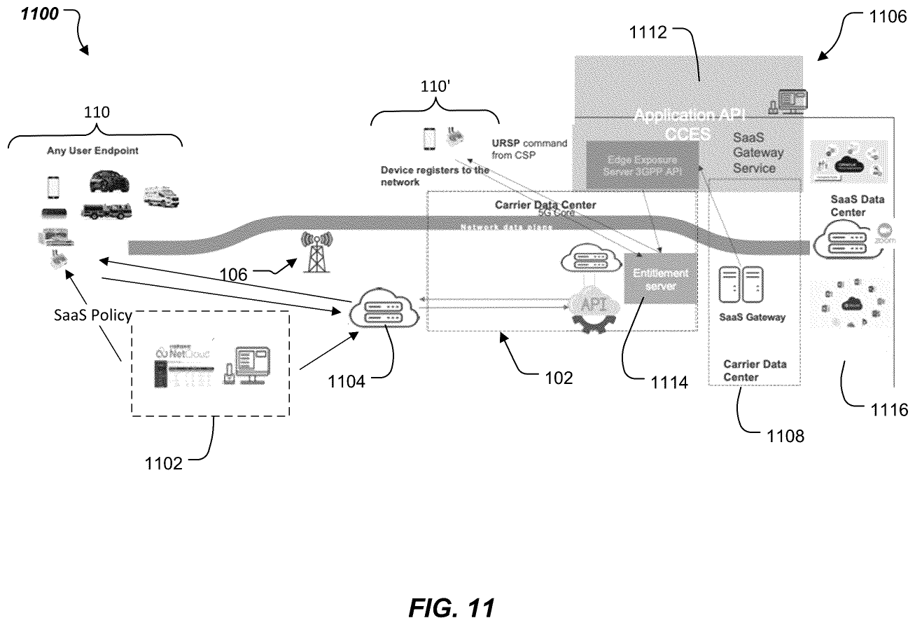

FIG. 11 is a schematic illustration of a system 1100 for providing SaaS optimization as a service offering in accordance with disclosed embodiments. As illustrated, a cloud service account 102 (e.g., Net Cloud Manager) allows an enterprise 1102 to use the cloud service account 102 control plane 1104 to create an SaaS policy which is sent down, as indicated by the arrow, to any user endpoint 110. The SaaS policy is mapped to the carrier network 106 using parameters such as MSISDN, SaaS Application, priority level, etc. The network 106 operator contract with users may provide for optimized services from, for example an SaaS data center 1116 associated with a SaaS vendor 1106 wherein a carrier query for the infrastructure security may be based on parameters such as MSISDN, SaaS Application, priority level, etc., and carrier control may be communicated based on the same parameters. An API infrastructure 1112 for SaaS vendor 1106 (e.g., Camara API, or the like) provides the location of the SaaS gateway service 1108 to the connecting user device (e.g., 110, 110′). Embodiments of system 1100 may include the information as part of the payload, it may be pushed as a USRP command, or the like, and may include carrier 106 feedback based on parameters such as MSISDN, SaaS Application, infrastructure gateway, infrastructure location IP address, and the like. Entitlement server 1114 becomes part of the infrastructure that merges the enterprise 1102 SaaS policy with the network 106 policy.

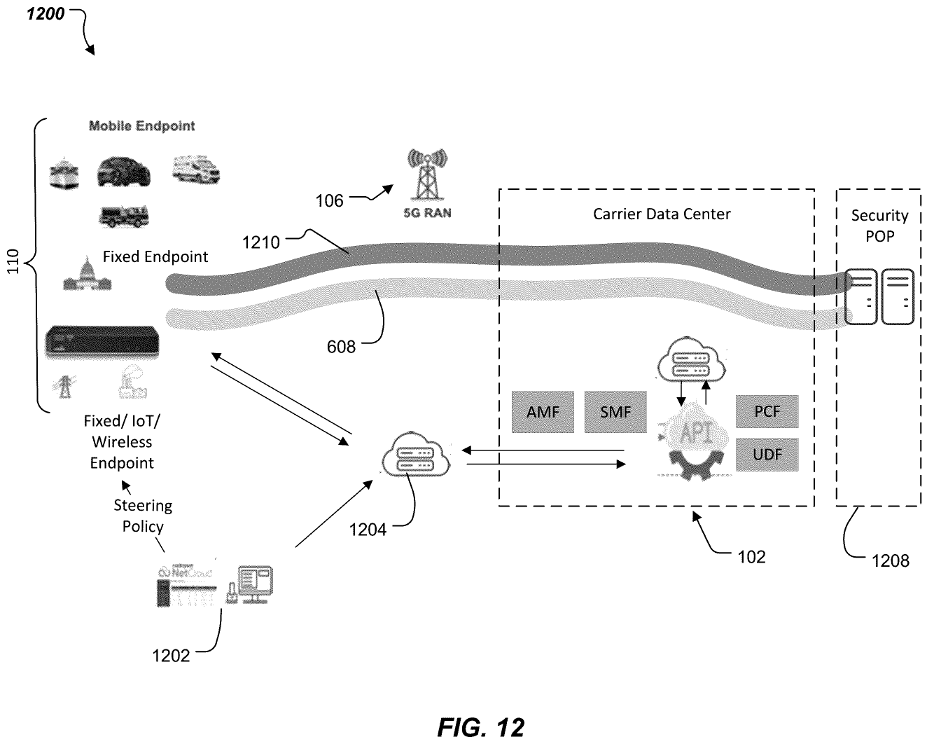

FIG. 12 is a schematic illustration of a system 1200 for providing an isolated secure network in the macro in accordance with disclosed embodiments. As illustrated, a cloud service account 102 (e.g., Net Cloud Manager) allows an enterprise 1202 to use the cloud service account 102 control plane 1204 to create a steering policy to define a secure slice 1210 defined by parameters such as application, enterprise type, application isolation level, and the like, and which policy is sent down, as indicated by the arrow, to any user endpoint 110 including mobile, fixed, IoT, wireless, and other endpoints. Subscription queries and carrier queries for security infrastructure are handled between the control plane 1204 and the cloud service account 102 API infrastructure (e.g., Access and Mobility Management Function (AMF), Session Management Function (SMF), Point Coordination Function (PCF), Unified Data Management (UDM), and the like) and may be based on parameters such as MSISDN, enterprise type, slice definition, slice authorization level, MSISDN authorization and the like, as communicated by carrier data center 1208 and a security POP. Carrier control may be communicated from control plane 1204 to connected devices 110 based on the same parameters as above and may also include parameters such as application policy, slice isolation level, device authorization, slice usage, and the like. In some embodiments the steering policy may be transmitted to the carrier network 106 using the same parameters allowing for a marketplace of security offerings to enable enterprises 1202 to configure policies to their compliance needs. Other embodiments are also possible.

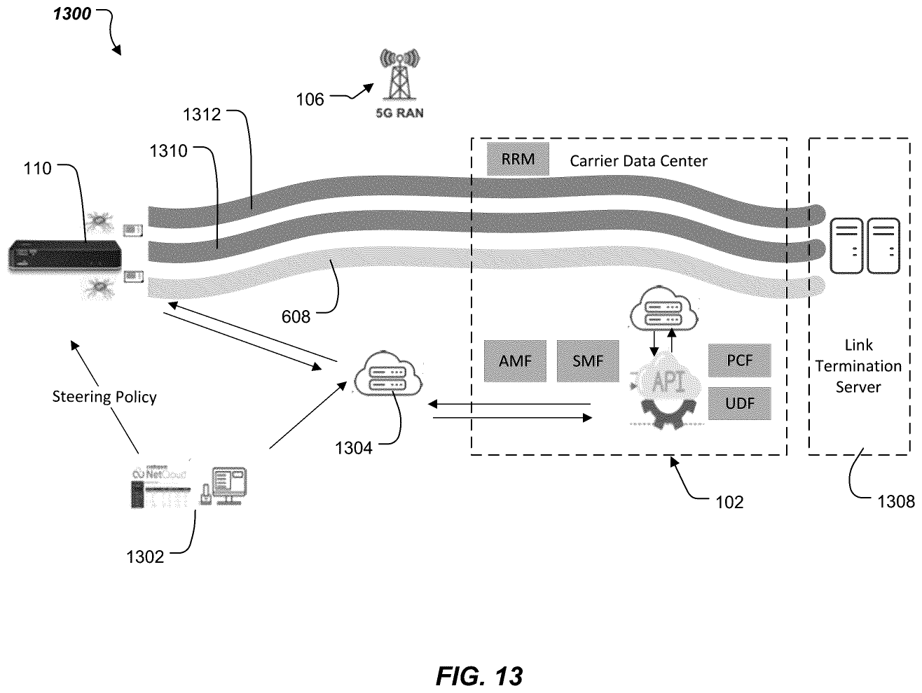

FIG. 13 is a schematic illustration of a system 1300 for providing service resiliency and band aggregation in accordance with disclosed embodiments. As illustrated, a cloud service account 102 (e.g., Net Cloud Manager) allows an enterprise 1302 to use the cloud service account 102 control plane 1304 to create a steering policy (e.g., arrow in FIG. 13) based on parameters such as application, WAN bonding profile, and the like, to define multiple slices 1310, 1312 as a subscription for multiple SIMs (shown schematically with device 110). The cloud account 102 API infrastructure (e.g., AMF, SMF, PCF, UDF, RRM, and the like) provide subscribed slices per SIM in device 110. Multiple modem/SIM connections may be combined to form a steering policy based on bonded links. Subscription queries and carrier queries for security infrastructure are handled between the control plane 1304 and the cloud service account 102 API infrastructure (e.g., AMF, SMF, PCF, UDF, RRM, and the like) and may be based on parameters such as MSISDN, enterprise type, slice definition, slice authorization level, MSISDN authorization and the like, as communicated by carrier data center 1308 and link termination server. Carrier control may be communicated from control plane 1304 to connected devices 110 based on the same parameters as above and may also include parameters such as bonding policy, device authorization, slice usage, and the like. Other embodiments are also possible.

Although various embodiments have been shown and described, the present disclosure is not so limited and will be understood to include all such modifications and variations would be apparent to one skilled in the art.

What is claimed is:

1. A system for providing Software as a Service (SaaS) optimization as a service offering in a 5G network, the system comprising:
a network device, including a device processor, configured to communicate over at least a 5G network wherein the network device comprises a set of instructions to cause the device processor to implement an enterprise policy for SaaS optimization over 5G network infrastructure;
a data center, including a data center processor, in communication with at least the 5G network wherein the data center includes a set of instructions to cause the data center processor to respond to the network device implementing the enterprise policy for SaaS optimization by mapping the enterprise policy for SaaS optimization to the 5G network infrastructure; and
a service account processor that includes a set of instructions to provide a service account control plane configured to enable a user to configure the enterprise policy for SaaS optimization.

2. A system for providing Software as a Service (SaaS) optimization as a service offering in a 5G network, the system comprising:
a service account gateway, including a gateway processor, configured to include a set of instructions to provide a service account control plane configured to enable a user to configure at least one enterprise SaaS optimization policy, and a set of instructions to push the at least one enterprise SaaS optimization policy to a network device;
the network device, including a device processor, configured to communicate over at least a 5G network wherein the network device comprises a set of instructions to cause the device processor to map the at least one enterprise SaaS optimization policy to a 5G network infrastructure; and
a data center, including a data center processor, in communication with at least the 5G network wherein the data center includes a set of instructions to cause the data center processor to maintain the at least one enterprise SaaS optimization policy.

3. A method for providing Software as a Service (Saas) optimization as a service offering in a 5G network, the method comprising:
configuring a network device, including a device processor, to communicate over at least a 5G network wherein the network device comprises a set of instructions to cause the device processor to implement an enterprise policy for SaaS optimization over 5G network infrastructure;
communicating from a data center, including a data center processor, with at least the 5G network wherein the data center includes a set of instructions to cause the data center processor to respond to the network device implementing the enterprise policy for SaaS optimization by mapping the enterprise policy for SaaS optimization to the 5G network infrastructure; and
configuring a service account processor that includes a set of instructions to provide a service account control plane configured to enable a user to configure the enterprise policy for SaaS optimization.

4. A method for providing Software as a Service (SaaS) optimization as a service offering in a 5G network, the method comprising:
configuring a service account gateway, including a gateway processor, to include a set of instructions to provide a service account control plane configured to enable a user to configure at least one enterprise SaaS optimization policy, and a set of instructions to push the at least one enterprise SaaS optimization policy to a network device;
configuring the network device, including a device processor, to communicate over at least a 5G network wherein the network device comprises a set of instructions to cause the device processor to map the at least one enterprise SaaS optimization policy to a 5G network infrastructure; and
communicating from a data center, including a data center processor, with at least the 5G network wherein the data center includes a set of instructions to cause the data center processor to maintain the at least one enterprise SaaS optimization policy.
